(19) United States
(12) Patent Application Publication
(10) Pub. No.: US 2017/0064289 A1
(43) Pub. Date: Mar. 2, 2017

(54) SYSTEM AND METHOD FOR CAPTURING AND DISPLAYING IMAGES

(71) Applicant: HOLUMINO LIMITED, Hong Kong (CN)

(72) Inventors: Tim Fu LO, Hong Kong (CN); Kwun Wah TONG, Hong Kong (CN)

(21) Appl. No.: 15/246,823

(22) Filed: Aug. 25, 2016

Related U.S. Application Data
(60) Provisional application No. 62/209,884, filed on Aug. 26, 2015.

(51) Int. Cl. H04N 13/02; H04N 13/04; G06T 13/20; H04N 13/00; G06T 19/00; H04N 5/232; G06T 19/20

(52) U.S. Cl. CPC H04N 13/0264; H04N 5/23293; H04N 5/23238; H04N 13/044; G06T 19/20; H04N 13/0014; H04N 5/23216; H04N 13/004; H04N 13/0484; H04N 13/0022; G06T 19/006; G06T 13/20; G06T 2210/22; G06F 3/04883

(57) ABSTRACT

Apparatus, systems, and methods for capturing and displaying images so as to create a new way of visualizing images and to provide applications in virtual reality environments are disclosed. A particular embodiment is configured to: capture an image at a position defined as a start point using the image capture device; move or rotate the image capture device in a circular path to capture a sequence of still images based on a time interval or an angle of rotation determined by the sensor device; and stay the image capture device in a fixed location for a certain period of time to enable the automatic capture of one or more video clips by use of the image capture device.

### PRIORITY PATENT APPLICATION

This is a non-provisional patent application claiming priority to U.S. provisional patent application, Ser. No. 62/209,884; filed Aug. 26, 2015. This non-provisional patent application draws priority from the referenced provisional patent application. The entire disclosure of the referenced patent application is considered part of the disclosure of the present application and is hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever. The following notice applies to the disclosure herein and to the drawings that form a part of this document: Copyright 2015-2016, Holumino Limited, All Rights Reserved.

### TECHNICAL FIELD

This patent document pertains generally to apparatus, systems, and methods for capturing and displaying images, although not exclusively, to apparatus, systems, and methods for capturing and displaying the images so as to create a new way of visualizing images and to provide applications in virtual reality environments.

### BACKGROUND

Panoramic photography may be defined generally as a photographic technique for capturing images with elongated fields of view. An image showing a field of view approximating, or greater than, that of the human eye, e.g., about 160° wide by 75° high, may be termed “panoramic.” Thus, panoramic images generally have an aspect ratio of 2:1 or larger, meaning that the image is at least twice as wide as it is high (or, conversely, twice as high as it is wide, in the case of vertical panoramic images). In some embodiments, panoramic images may even cover fields of view of up to 360 degrees, i.e., a “full rotation” panoramic image.

There are many challenges associated with taking visually appealing panoramic images. These challenges include photographic problems such as: difficulty in determining appropriate exposure settings caused by differences in lighting conditions across the panoramic scene; blurring across the seams of images caused by the motion of objects within the panoramic scene; and parallax problems, i.e., problems caused by the apparent displacement or difference in the apparent position of an object in the panoramic scene in consecutive captured images due to rotation of the image capture device about an axis other than its center of perspective (COP). The COP may be thought of as the point where the lines of sight viewed by the image capture device converge. The COP is also sometimes referred to as the “entrance pupil.” Depending on the image capture device's lens design, the entrance pupil location on the optical axis of the image capture device may be behind, within, or even in front of the lens system. It usually requires some amount of pre-capture experimentation, as well as the use of a rotatable tripod arrangement with an image capture device sliding assembly to ensure that an image capture device is rotated about its COP during the capture of a panoramic scene. This type of preparation and calculation is not desirable in the world of handheld, personal electronic devices and ad-hoc panoramic image capturing.

Other challenges associated with taking visually appealing panoramic images include post-processing problems such as: properly aligning the various images used to construct the overall panoramic image; blending between the overlapping regions of various images used to construct the overall panoramic image; choosing an image projection correction (e.g., rectangular, cylindrical, Mercator, etc.) that does not distort photographically important parts of the panoramic photograph; and correcting for perspective changes between subsequently captured images.

Further, it can be a challenge for a photographer to track his or her progress during a panoramic sweep, potentially resulting in the field of view of the image capture device gradually drifting upwards or downwards during the sweep (in the case of a horizontal the panoramic sweep). Some prior art panoramic photography systems assemble the constituent images to create the resultant panoramic image long after the constituent images have been captured, and often with the use of expensive post-processing software. If the coverage of the captured constituent images turns out to be insufficient to assemble the resultant panoramic image, the user is left without recourse. Heretofore, panoramic photography systems have been unable to generate a full resolution version of the panoramic image during the panoramic sweep, such that the full resolution version of the panoramic image is ready for storage and/or viewing at substantially the same time as the panoramic sweep is completed by the user.

Accordingly, there is a need for techniques to improve the capture and processing of panoramic photographs on handheld, personal electronic devices such as mobile phones, personal data assistants (PDAs), portable music players, digital cameras, as well as laptop and tablet computer systems.

### SUMMARY

In the various example embodiments described herein, a panorama image can refer to an image with wide-angle view. A panorama image can be comprised of a sequence of photos. Multiple photos are captured in a certain time interval or by judgement on the environment coverage by rotating a camera or other image capture device in a generally horizontal line or path. The multiple photos are then automatically combined into a panorama by a stitching process performed by an image and data processing system. In the various example embodiments described herein, the multiple photos stitched together can include both still images and motion video clips. Current panorama applications are limited to still images only, aiming at illustrating the overall environment of a place or design of a physical object.

In the various example embodiments described herein, the method of panorama capture can be applied to a photosphere. A photosphere can be defined as an arbitrary three-dimensional (3D) space, typically in a spherical shape. In addition to rotation of the image capture device in a generally horizontal line, the image capture device can also be moved up and down to cover and capture the whole photosphere environment in a sphere. The photosphere can be achieved after a stitching process performed by the image and data processing system, similar to the generation of the panorama.

In the various example embodiments described herein, the photosphere can be applied in Virtual Reality (VR) environment with the use of VR headsets. Current Virtual Reality environments are displayed on a computer screen or special stereoscopic displays. The device displaying the images can be worn as a headset. In the various example embodiments described herein, the photosphere can be split into two parts for right and left eyes and displayed in the headset, so that an immersive user experience in viewing a particular photosphere can be achieved. Some simulations including additional sensory information and sound effects enhance the sense of reality.

The various example embodiments described herein provide a system and a method of image capturing to create a new form of image stream: an animated image stream, which is comprised of an integrated combination of both still photo components and video components at the same time. The capturing gesture of moving an image capture device and holding or staying the image capture device in a fixed place to capture motion video contribute to the capture of an animated image. With this characteristic or gesture of moving and/or staying the camera (or other image capture device) to capture a panorama or photosphere, the effect can be extended from a still photo to an animated panorama/photosphere, thereby creating an “animated image stream.”

The rotating gesture of the image capture device can capture stereoscopic photos. The gesture of moving the image capture device from left to right (or from right to left) can enable the image capture device to capture photos with a simulation of a left eye perspective view and a right eye perspective view, respectively. A data processing and image processing procedure of an example embodiment can retrieve an angular measurement or a degree of rotation from the gesture of moving the image capture device. A degree of angular difference can be determined between two adjacent photos. As a result, a stereoscopic depth can be seen by human eyes. This stereoscopic depth, known as stereoscopic 3D, captured by the various example embodiments using one image capture device is the same effect as captured by traditional 3D capture devices using dual cameras.

The images captured by the various example embodiments can be viewed by a user with a display device having a display screen and an inertia sensor (e.g., gyroscope, or the like). Sensor data from the inertia sensor can be retained as metadata associated with the captured images. Different parts of the photo can be displayed with various gestures on the display device; the viewing angle is in accordance with capturing angle.

The various example embodiments described herein can be applied in a Virtual Reality application or environment to produce an immersive experience in viewing a photo. With the inertia sensor of the display device, the photo angle fits the viewer's viewing angle. Pairs of stereoscopic photos can also be identified; the identified photos are displayed on the display screen and divided into two parts at the same time for each of the user's eyes. The photos can be displayed in 3D with stereoscopic depth as during capture, parallax distance is applied in virtual reality. Viewing the photos in virtual reality is immersive and stereoscopic with depth.

### BRIEF DESCRIPTION OF THE DRAWINGS

The various embodiments are illustrated by way of example, and not by way of limitation, in the figures of the accompanying drawings in which:

FIG. 1 illustrates an example embodiment for capturing a panorama by rotating or spinning the image capture device (e.g., a mobile device, mobile phone, etc.) against the center of the human body of a user;

FIG. 2 illustrates an example embodiment wherein photos can be automatically captured one after another when the user turns, rotates, or spins with the image capture device through a specific angle or degree of rotation;

FIG. 3 illustrates an example embodiment wherein a plurality of photos and/or video clips as part of an animated panorama can be automatically captured one after another when the user rotates or spins with the image capture device through a specific angle or degree of rotation;

FIG. 4 illustrates an example embodiment wherein a plurality of photos and/or video clips can be automatically captured as part of an animated panorama;

FIG. 5 illustrates an example embodiment for displaying a sequence of images by arranging information on a display screen to show certain frames in an image sequence, wherein different parts of the image sequence can be seen by using gestures on a touch screen or other user input device of a mobile device;

FIG. 6 illustrates an example embodiment for capturing images providing a stereoscopic effect;

FIG. 7 illustrates an example embodiment wherein the degree of angular rotation (S°) between any of the captured images can be computed;

FIG. 8 illustrates the example embodiment for adjusting the specific angle between captured images to correspond to the parallax angle for the user's left and right eyes;

FIG. 9 illustrates an example embodiment of a method and system for displaying sets of images providing a stereoscopic effect, wherein two sets of stitched images with an applied angle perspective difference are displayed side by side for the left and right eyes of the user;

FIG. 10 illustrates an example embodiment wherein a portion of a frame can be selected and the subsequent frames can be cropped accordingly;

FIG. 11 illustrates an example embodiment for image stitching for stereoscopic 3D for the left eye;

FIG. 12 illustrates an example embodiment wherein the last frame of the stitched image set is connected with the first frame for a 360 degree angle view;

FIG. 13 illustrates an example embodiment for image stitching for stereoscopic 3D for the right eye;

FIG. 14 illustrates an example embodiment wherein the last frame of the stitched image set is connected with the first frame for a 360 degree angle view;

FIGS. 15 and 16 illustrate an example embodiment that includes a stitching process for generating a stitched background image for video;

FIG. 17 illustrates an example embodiment wherein a video clip captured by an image capture device can be inserted on a background image at a specific angular degree thereby replacing the still images at the corresponding specific angular degree;

FIG. 18 illustrates a block diagram of an example mobile device in which the embodiments described herein may be implemented; and

FIGS. 19 through 21 are processing flow diagrams illustrating example embodiments of systems and methods for image capture, processing, and display.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details. As described in various example embodiments, apparatus, systems, and methods for capturing and displaying images so as to create a new way of visualizing images and to provide applications in virtual reality environments are described herein.

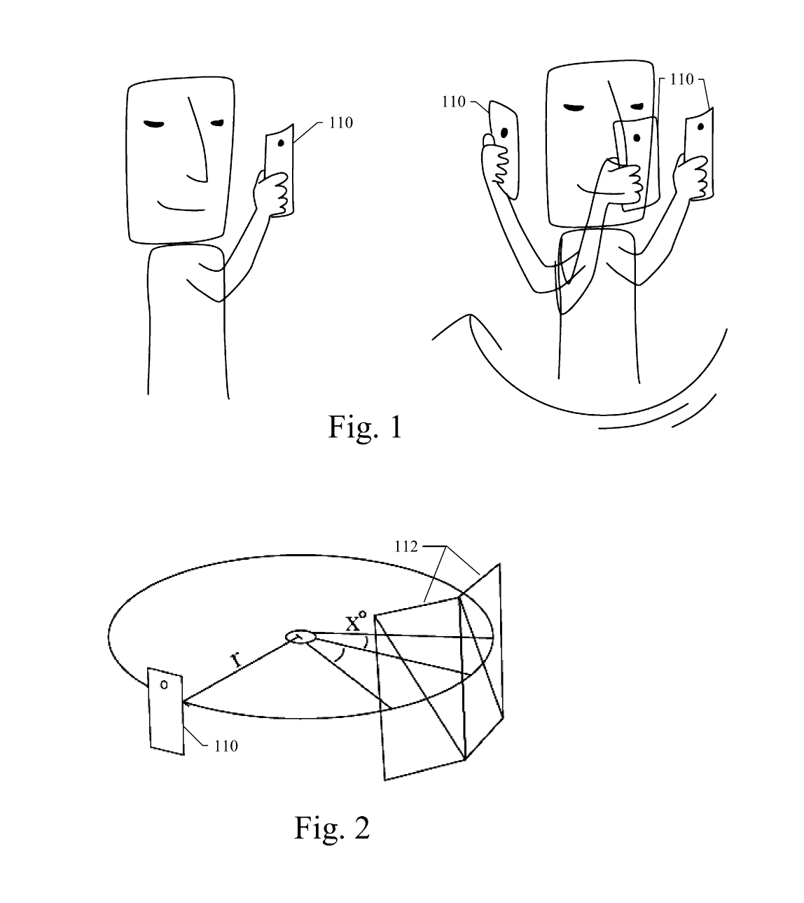

FIG. 1 illustrates an example embodiment for capturing a panorama by rotating or spinning the image capture device 110 (e.g., a mobile device, mobile phone, etc.) against the center of the human body of a user. FIG. 2 illustrates an example embodiment wherein photos can be automatically captured one after another when the user turns, rotates, or spins with the image capture device 110 through a specific angle or degree of rotation ‘x’. As shown in FIG. 2, ‘r’ represents a radius or a distance between the image capture device 110 and the center of rotation. The example embodiment automatically captures a photo for each specific angle or degree of rotation ‘x’ through which the user rotates or spins the image capture device 110 from a starting point. In a particular embodiment, the axis of rotation is parallel to the force of gravity (vertical) and thereby creates a rotation around a horizontal plane parallel with the ground. However, as described in more detail below, the axis of rotation can also be horizontal or angular to create a vertical or angular plane of rotation, such as for creation of a set of images for a photosphere.

In accordance with an example embodiment shown in FIG. 1, there is provided a method and system for capturing images, the method comprising: capturing an image at a position defined as a start point using an image capture device; moving or rotating the image capture device along a plane (e.g., a circular path) to capture a sequence of still images based on a time interval or an angle of rotation determined by a sensor device; and staying the image capture device (e.g., holding the image capture device immobile) in a fixed location for a certain period of time to enable the automatic capture of a video clip by use of the image capture device.

In accordance with an example embodiment shown in FIG. 2, a sequence of still images 112 is recorded during a movement gesture (e.g., spinning or rotation) of the image capture device 110 with rotational or angular degree information collected from an inertia sensor (e.g. gyroscope, or the like) in the image capture device 110. The sensor data with the rotational or angular degree information from the inertia sensor can be retained as metadata associated with the captured images 112. As shown in FIG. 2, a photo is captured for every ‘x’ degree with a distance ‘r’ from center; where ‘r’ is the distance between the capture device and the rotating center, and ‘x’ is the specific degree to store the photo in sequence.

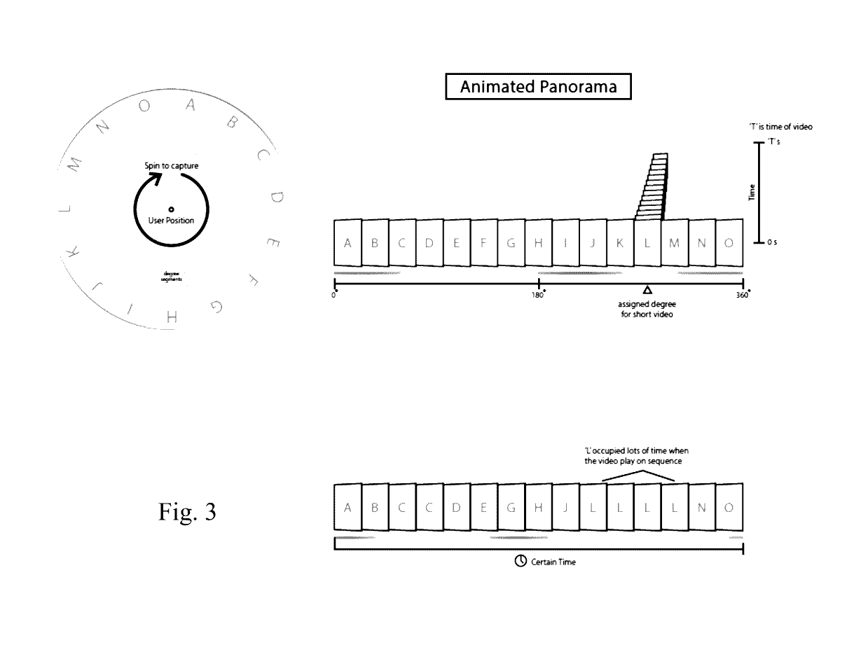

FIG. 3 illustrates an example embodiment wherein a plurality of photos and/or video clips as part of an animated panorama can be automatically captured one after another when the user rotates or spins with the image capture device 110 through a specific angle or degree of rotation. In a particular embodiment, an animated panorama including a combination of both still images and one or more video clips can be denoted a semi-video or a semi-video content item. As shown in FIG. 3, all photos are well-organized and sequenced by the angle or degree of capture, wherein each angle is fully captured, and a specific angle associated with a short video can be assigned by users. Both still pictures and video can be combined as semi-video. In the example embodiment shown in FIG. 3, still images can be associated with a particular time period and/or angle or degree of rotation and video clips can be associated with one or more time periods and/or one or more angles or degrees of rotation. Traditional video capture cannot provide the experience of space as provided with the various embodiments disclosed herein. The various embodiments provide a sequence of images or video captured in certain time without the need for a concept of space. As shown in FIG. 3, a semi-video with gyroscope metadata can be applied. All photos are well-organized by degree, each angle is fully captured, and the specific angle with the short video can be assigned by users. Normal video mode can be applied with a gesture.

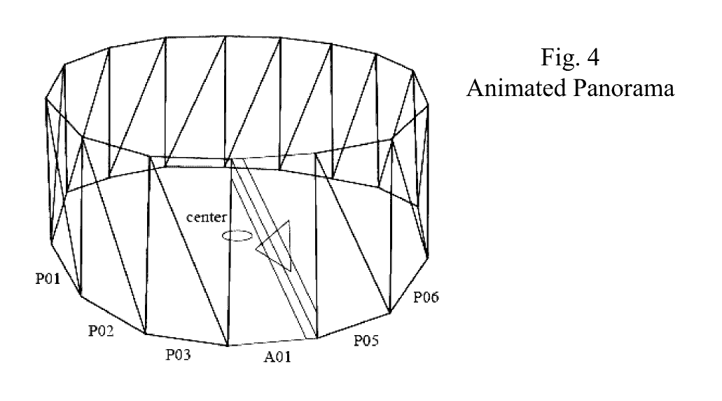

FIG. 4 illustrates an example embodiment wherein a plurality of photos and/or video clips can be automatically captured as part of an animated panorama. In accordance with an example embodiment, there is provided a method and system for capturing images, the method comprising: capturing an image at a position which is defined as a start point; moving or rotating the image capture device along a plane to capture a sequence of still images based on a time interval or environmental coverage; and staying the image capture device (e.g., holding the image capture device immobile) in a fixed location for a certain of time to capture a video clip. The capturing gesture of moving/rotating and staying the image capture device contributes to the capture of the animated panorama. In each of these capturing gestures, the still images and/or video clips are automatically captured by the image capture device without individual explicit user action required. With this characteristic provided by the various embodiments disclosed herein of moving the image capture device to capture a panorama or photosphere, the effect can be extended from a still photo to an animated panorama or photosphere (e.g., an “animated image stream”) containing a collection of integrated still images and video clips arranged in a temporal and/or angular relationship. As shown in FIG. 4, photos can be automatically captured every ‘x’ degrees of rotation (e.g., P01 to P06). A video clip can be captured with a specific rotational angle or degree position (e.g., A01). In this case, one of the ‘x’ degree positions of rotation is associated with a stored video clip, not a still photo. In the example embodiment, the implementation is not limited to one video clip in each full circle spin recording. Multiple videos can be stored in a full 360 degree panorama for any or every ‘x’ degree.

In an implementation of an example embodiment, the captured images can be a sequence of still photos and/or video(s). In an example embodiment, an animated image stream can be a hybrid integration of still photos and video clips. Part of the image sequence can be presented as still images while a part of the image sequence can be presented as playing video(s). Again, this presentation of a hybrid collection of photos and videos does not require explicit individual user action to create the components of the hybrid collection. In an implementation of an example embodiment, the example embodiment can generate an output file structure that includes a sequence of one or more still images, a sequence of zero or more video clip(s), and a related text file including metadata and image sequencing data. In an implementation of an example embodiment, the example embodiment can use high shutter speeds of the image capture device to enhance the smoothness of capture procedure described above and the quality of the images produced thereby. In an implementation of an example embodiment, using the capture procedure described above, a 360 degree panorama can be captured by moving the image capture device in a 360 degree circle. Additionally, in an implementation of an example embodiment, using the capture procedure described above, a 360 degree photosphere can be captured by moving the image capture device in a 360 degree spherical space.

FIG. 5 illustrates an example embodiment for displaying a sequence of images (with or without image stitching), the method comprising: arranging information on a display screen to show certain frames in an image sequence; and presenting different parts of the image sequence based on gestures or other user inputs applied on a touch screen or other user input device of a mobile device. For example, to browse the left side of the image sequence taken, the currently displayed image or video is changed sequentially in a counter-clockwise direction from P01 up to P06 in ascending order. To browse the right side of the image sequence taken, the currently displayed image or video is changed sequentially in a clockwise direction from P06 down to P01 in descending order. As such, an example embodiment uses the display or viewing device of a mobile device to present a certain frame in an image sequence for both still images or video(s); when browsing the image or video that was captured in a specific angular rotational degree or time period, the corresponding image or video clip will be shown or played automatically by the example embodiment.

In accordance with an example embodiment, there is provided a method and system for displaying images, the method comprising: activating a display screen arranged to show a part of an image sequence, wherein the images of the image sequence are arranged based on sensor data from an inertia sensor (e.g., gyroscope) and the viewing angles of the images of the image sequence are arranged in accordance with capturing angles; and displaying different parts of the image sequence by enabling a user gesture on a touch screen or other input device, the gesture including dragging the touch screen or other input device or using a cursor device on a computer.

In an implementation of an example embodiment, the images of the image sequence can include one or more motion video clips thereby producing a partially animated image sequence. The partially animated image sequence can be displayed using a display screen of a mobile device. The viewing of different parts of the partially animated image sequence can be achieved by rotating the display screen and the mobile device to different directions or angles corresponding to the desired portions of the partially animated image sequence. The different directions or angles can be determined by using an inertia sensor (e.g., gyroscope) in the mobile device. Processing logic of an example embodiment can retrieve or compute the direction, angle, or degree of rotation of the mobile device to determine which portion of the partially animated image sequence to display. Sensor data corresponding to the direction, angle, or degree of rotation can be recorded by an inertia sensor in the mobile device. This data is used in displaying the different parts of the partially animated image sequence by sensing the rotation of the mobile device, which is in accordance with the degree of rotation of the image or video capture as described above. In an example embodiment, a database or dictionary can be used to match the data recorded by the inertia sensor as applied to the degree of rotation of the image capture and the corresponding portion of the partially animated image sequence. The moving or rotation angle of the mobile device can be used to select a desired portion of the partially animated image sequence in accordance with the moving or rotation angle corresponding to the image or video capture. In an example embodiment, in addition to using an inertia sensor in the mobile device to select a desired portion of the partially animated image sequence as described above, a user can also select a desired portion of the partially animated image sequence by using gestures on a touch screen or other user input device of the mobile device, such as dragging on a touch screen display or dragging using a cursor on a computer display. In a particular embodiment, the viewing device can display a certain frame in the image sequence for either still images or video(s). When browsing the image or video that was captured in a specific angular rotational degree or time period, the corresponding image or video clip will be shown or played automatically by the example embodiment.

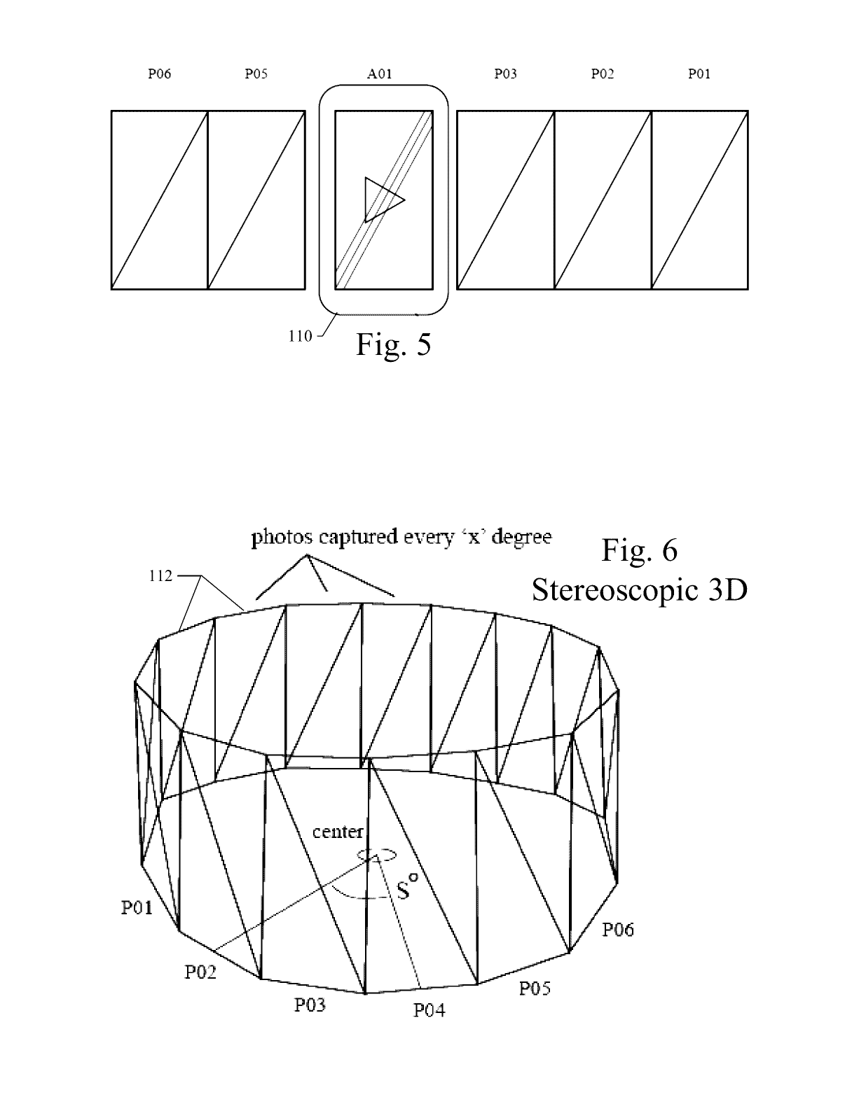

Referring now to FIG. 6, in accordance with an example embodiment, there is provided a method and system for capturing images providing a stereoscopic effect. As described above, a sequence of still images 112 can be recorded during a movement gesture (e.g., spinning or rotation) of the image capture device 110 with rotational or angular degree information collected from an inertia sensor (e.g., gyroscope, or the like) in the image capture device 110. The sensor data with the rotational or angular degree information from the inertia sensor can be retained as metadata associated with the captured images 112. The movement or rotating gesture moves the image capture device 110 along a path.

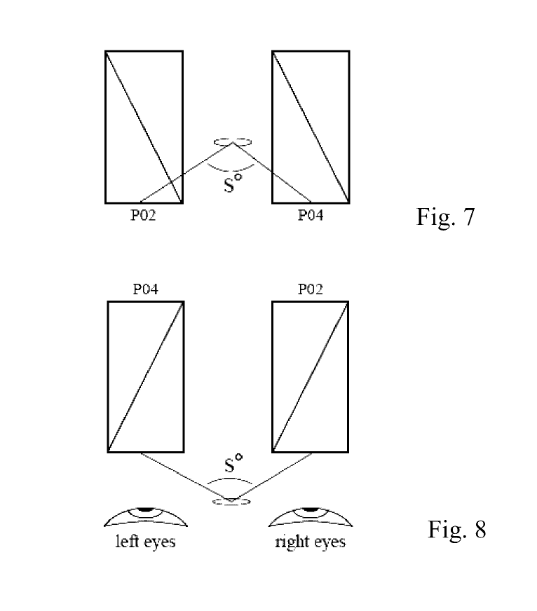

As shown in FIGS. 6 and 7, the degree of angular rotation (S°)between any of the captured images 112 can be computed from the angular degree information from the inertia sensor of the image capture device 110. As shown in FIG. 8, the angular distance or measurement corresponding to the parallax for a user's left and right eyes can also be computed or retrieved as a fixed pre-defined value. The parallax angle for the user's left and right eyes can correspond to the typical depth perception for human eyes when viewing a 3D image or scene. In this manner, an example embodiment can simulate the position view and parallax angle for the user's left and right eyes. As shown in FIGS. 7 and 8, the example embodiment can adjust the specific angle between captured images 112 to correspond to the parallax angle for the user's left and right eyes. As a result, the movement or rotating gesture of moving the image capture device 110 from left to right (or from right to left), can cause the image capture device 110 to capture photos in an appropriate angular rotation to simulate left eye perspective and right eye perspective, respectively. As shown in FIGS. 7 and 8, captured photos P02 and P04 are captured between a specific angle difference of ‘s’ degrees from center. By using the specific angle difference of ‘s’ degrees of the two captured photos P02 and P04, the images are represented as a 3D photo with depth for the human eyes. Thus, the example embodiments can produce a stereoscopic 3D effect.

In an implementation of an example embodiment, capture of stereoscopic photos can be performed by moving the camera of the image capture device 110 along a path. The processing logic in an example embodiment can calculate the angle or distance for parallax for both eyes. The sequence of captured stereoscopic photos with angle data is recorded. In an implementation of an example embodiment, an angular degree difference can be produced between two photos of the captured stereoscopic photos to correspond to the parallax angle of the user's eyes. In this manner, the example embodiment can simulate the stereoscopic depth or stereoscopic 3D seen by human eyes. The example embodiments improve existing computer technology by enabling the simulation of stereoscopic 3D by use of s single camera of an image capture device 110. In conventional technologies, such stereoscopic 3D can only be captured by traditional 3D capture devices with two or more cameras.

In an implementation of an example embodiment, the display device or viewing device displays a certain frame in the image sequence for either still images or video(s). When browsing the image or video that was captured in a specific angular rotational degree or time period, the corresponding image or video clip will be shown or played automatically by the example embodiment. In an implementation of an example embodiment, a method and system for capturing stereoscopic image comprises: rotating an image capture device along a path, which provides an image source for both eyes, the method including deriving the position view for the left and right eyes during moving or rotation of the image capture device. In the example embodiment, the rotation or movement gesture by the user can cause the moving of the image capture device in either a clockwise or counter-clockwise direction. As a result, the image capture device can capture images with a simulation of left eye perspective and a simulation of right eye perspective, respectively (vice versa for reverse direction). In an example embodiment, a method and system for displaying images with stereoscopic effect can comprise: identifying a pair of stereoscopic photos; and displaying the identified photos on the display screen at the same time for both eyes. In an example embodiment, the display screen is divided into two parts to show the pair of stereoscopic photos, a stream of stereoscopic photos for the left eye and a different stream of stereoscopic photos for the right eye, wherein a parallax angle is applied between the two streams of stereoscopic photos to produce the stereoscopic effect. In an example embodiment, the sequence of photos with angle data can be retrieved. In an example embodiment, the display screen is divided into two parts for the left and right eyes, respectively. Each stream of stereoscopic photos for the left and right eyes contains a specific angular degree difference, which creates the stereoscopic depth seen by human eyes. In an example embodiment, the stereoscopic effect can be produced with multiple images in different angles without the need of traditional stitching for a panorama. In an example embodiment, a stereoscopic photo viewing system in the example embodiment can be constructed by putting a display device into a virtual reality headset. In the example embodiment, while rotating the headset with the display device, a user can view different angles of the images and different portions of the sequences of captured stereoscopic photos.

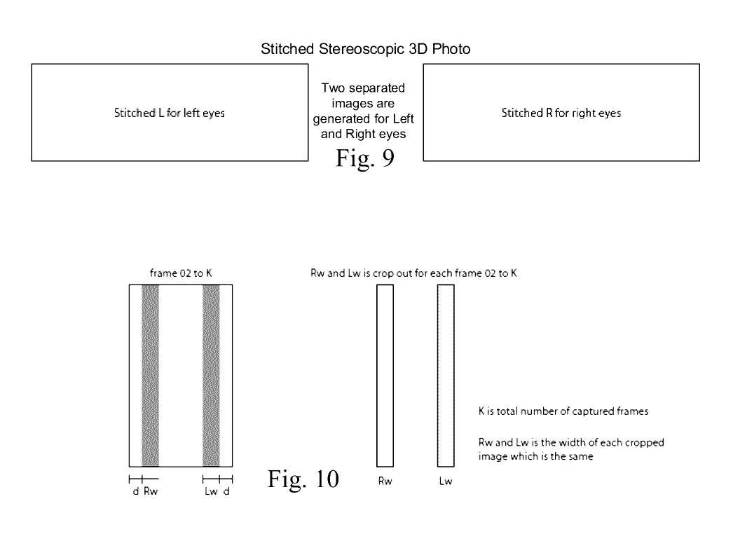

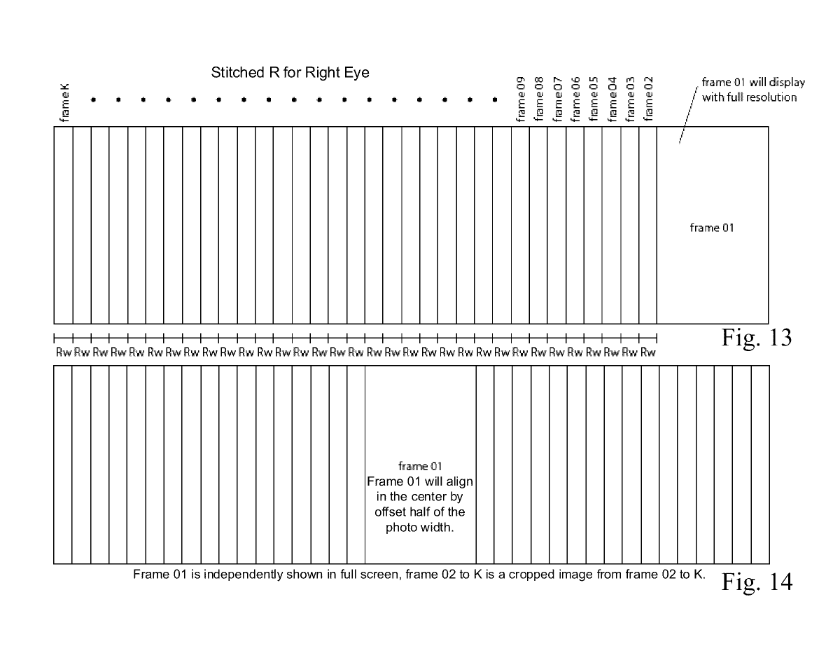

Referring now to FIGS. 9 through 11, an example embodiment includes a method and system for image stitching for stereoscopic 3D for the left eye. Referring also to FIGS. 9, 10, and 13, an example embodiment includes a method and system for image stitching for stereoscopic 3D for the right eye. In the example embodiment as shown in FIGS. 11 through 14, one full frame of an image can be used as the first frame. For subsequent frames, a certain width (e.g., a pre-defined or configured width, Lw for the left eye and Rw for the right eye) or portion of the frame can be selected and the subsequent frames can be cropped accordingly (e.g., see FIG. 10). The first full frame and the cropped subsequent frames can be arranged together to form a wide angled stitched image set for the left eye (e.g., see FIGS. 9-11). The same first full frame used for the left eye and the cropped subsequent frames can also be arranged together to form a wide angled stitched image set for the right eye (e.g., see FIGS. 9, 10, and 13).

Referring now to FIG. 9, an example embodiment includes a method and system for displaying sets of images providing a stereoscopic effect, wherein two sets of stitched images with an applied angle perspective difference are displayed side by side for the left and right eyes of the user. In the example embodiment, the two sets of images are stitched together in the manner described above.

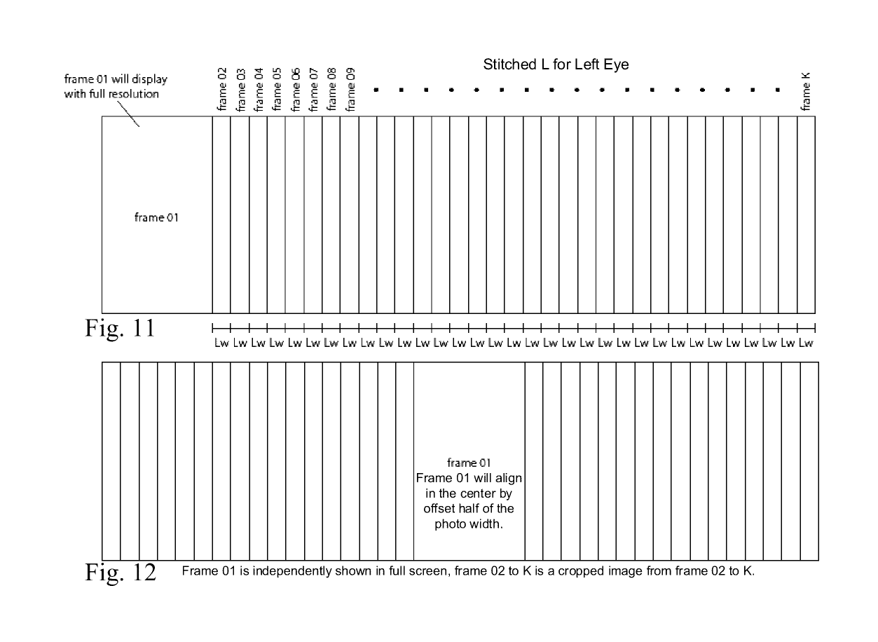

Referring now to FIGS. 12 and 14, an example embodiment includes a method and system, wherein the last frame of the stitched image set is connected with the first frame for a 360 degree angle view. In an example embodiment, pairs of stereoscopic photos are identified by matching the same first frame or the subsequent frames accordingly, and the matching frame pairs are shown at the same time side by side for the left and right eyes of the user. In an example embodiment, the display screen of a display device is divided into two parts, one part for the left eye of the user and the other part for the right eye of the user. Both photos displayed in each of the two parts of the display screen contain a specific angular degree difference, which corresponds to the parallax viewing angle of the user and creates or simulates a stereoscopic depth as seen by human eyes. In an example embodiment, a method and system for stitching one or more still image(s) and one or more video(s) comprises: arranging a stitched still image as a background in accordance with an angular degree; and overlaying a video at a certain degree range as an insertion of the video into the stitched still image.

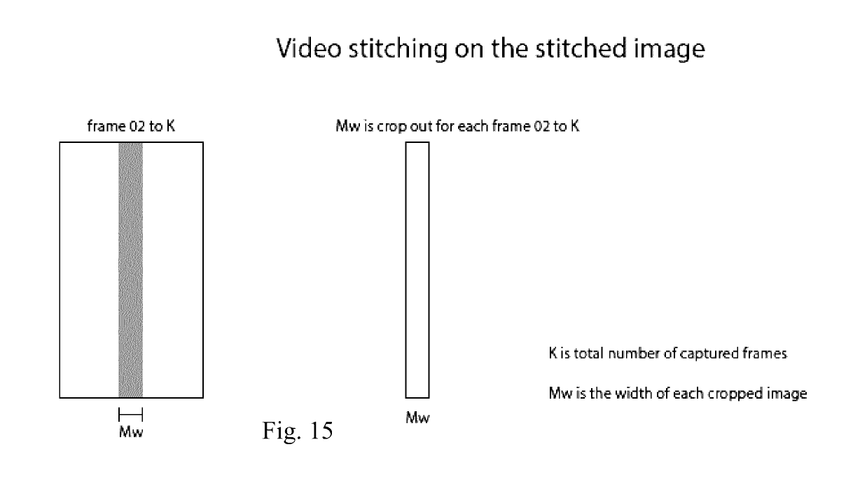

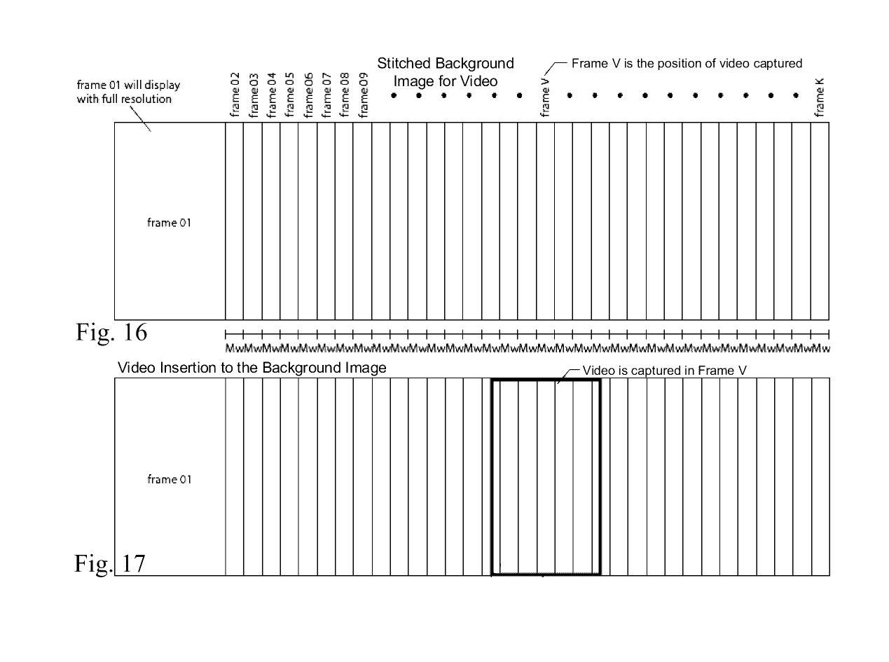

Referring to FIGS. 15 and 16, an example embodiment includes a method and system, wherein a stitching process for generating a stitched background image for video comprises: displaying a full frame with full resolution at the beginning; and displaying a sequence of cropped subsequent frames at a certain width according to the sequence of captured image frames.

Referring to FIG. 17, an example embodiment includes a method and system, wherein a video clip captured by an image capture device can be inserted on a background image at a specific angular degree thereby replacing the still images at the corresponding specific angular degree. The specific angular degree can be recorded by an inertia sensor (e.g., gyroscope) on the image capture device as described above. In an example embodiment, a method and system for displaying stitched images with video can comprise: arranging a display screen of a display device to show a certain part of a stitched image sequence. The different parts of the stitched image sequence can be selected and viewed by a user by use of a gesture control on a touch screen of a display device (e.g., swiping the touch screen) or by using the various user inputs or selection methods described above. In an example embodiment, different parts of the stitched image sequence can be selected and viewed by a user by moving or rotating the display device, wherein different parts of the stitched image sequence are shown in accordance with the angle to which the display device is rotated. In the example embodiment shown in FIG. 17, the video is aligned on the center of frame V and overlapped on the stitched background image. Lens distortion and edge blending can be applied to stitch the video with the background image. The video can be rendered after the video insertion process is complete.

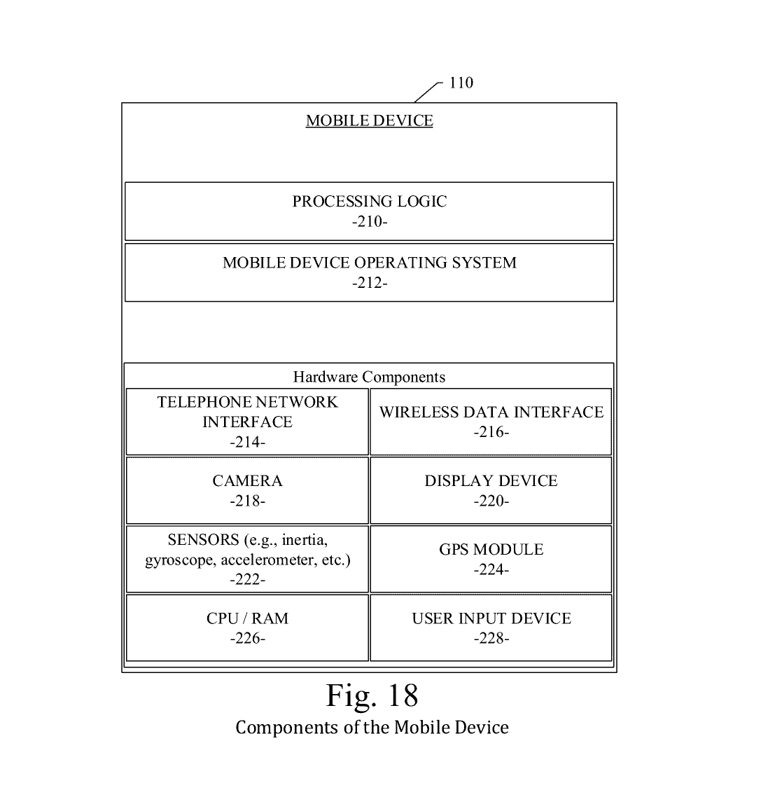

FIG. 18 illustrates a block diagram of an example mobile device 110 in which embodiments described herein may be implemented. In one example embodiment, a user mobile device 110 can run an operating system 212 and processing logic 210 to control the operation of the mobile device 110 and any installed applications. The mobile device 110 can include a personal computer (PC), a laptop computer, a tablet computing system, a Personal Digital Assistant (PDA), a cellular telephone, a smartphone, a web appliance, or any machine capable of executing a set of instructions (sequential or otherwise) or activating processing logic that specify actions to be taken by that machine. The mobile device 110 can further include a variety of subsystem components and interfaces, data/device interfaces, and network interfaces, such as a telephone network interface 214, a wireless data transceiver interface 216, a camera or other image capture device 218 for capturing either still images or motion video clips, a display device 220, a set of sensors 222 including an inertia sensor, gyroscope, accelerometer, etc., a global positioning system (GPS) module 224, a central processing unit (CPU) and random access memory (RAM) 226, and a user input device 228, such as a touch screen device, a cursor control device, a set of buttons, or the like. In example embodiments as described herein, the mobile device 110 can gather a variety of images or videos from the image capture device 218 and related sensor data from the sensor array 222. The mobile device 110 can aggregate the image and sensor data into a plurality of data blocks, which can be processed by a central processing unit (CPU) and random access memory (RAM) 226 in the mobile device 110, or transferred via a network interface (e.g., interfaces 214 or 216) and a wide area data network to a central server for further processing. Other users, customers, vendors, peers, players, or clients can access the processed image and sensor data via the wide area data network using web-enabled devices or mobile devices. The various embodiments disclosed herein can be used in a network environment to enable the sharing of the animated image sequences, including image sequences with only still images, partially animated image sequences with one or more video clips, stereoscopic image sequences, photospheric image sequences, or combinations thereof, captured and processed as described herein. In one embodiment, the animated image sequences can be transferred between a user and a virtual reality (VR) environment.

Referring still to FIG. 18, the mobile device 110 can include a central processing unit (CPU) 226 with a conventional random access memory (RAM). The CPU 226 can be implemented with any available microprocessor, microcontroller, application specific integrated circuit (ASIC), or the like. The mobile device 110 can also include a block memory, which can be implemented as any of a variety of data storage technologies, including standard dynamic random access memory (DRAM), Static RAM (SRAM), non-volatile memory, flash memory, solid-state drives (SSDs), mechanical hard disk drives, or any other conventional data storage technology. Block memory can be used in an example embodiment for the storage of raw image data, processed image data, and/or aggregated image and sensor data as described in more detail above. The mobile device 110 can also include a GPS receiver module 224 to support the receipt and processing of GPS data from the GPS satellite network. The GPS receiver module 224 can be implemented with any conventional GPS data receiving and processing unit. The mobile device 110 can also include a mobile device 110 operating system 212, which can be layered upon and executed by the CPU 226 processing platform. In one example embodiment, the mobile device 110 operating system 212 can be implemented using a LinuxTM based operating system. It will be apparent to those of ordinary skill in the art that alternative operating systems and processing platforms can be used to implement the mobile device 110. The mobile device 110 can also include processing logic 210 (e.g., image capture and display processing logic), which can be implemented in software, firmware, or hardware. The processing logic 210 implements the various methods for image capture, processing, and display of the example embodiments described in detail above.

In the example embodiment, the software or firmware components of the mobile device 110 (e.g., the processing logic 210 and the mobile device operating system 212) can be dynamically upgraded, modified, and/or augmented by use of a data connection with a networked node via a network. The mobile device 110 can periodically query a network node for updates or updates can be pushed to the mobile device 110. Additionally, the mobile device 110 can be remotely updated and/or remotely configured to add or modify the feature set described herein. The mobile device 110 can also be remotely updated and/or remotely configured to add or modify a specific characteristics.

As used herein and unless specified otherwise, the term mobile device includes any computing or communications device that can communicate as described herein to obtain read or write access to data signals, messages, or content communicated on a network and/or via any other mode of inter-process data communications. In many cases, the mobile device 110 is a handheld, portable device, such as a smart phone, mobile phone, cellular telephone, tablet computer, laptop computer, display pager, radio frequency (RF) device, infrared (IR) device, global positioning device (GPS), Personal Digital Assistant (PDA), handheld computer, wearable computer, portable game console, other mobile communication and/or computing device, or an integrated device combining one or more of the preceding devices, and the like. Additionally, the mobile device 110 can be a computing device, personal computer (PC), multiprocessor system, microprocessor-based or programmable consumer electronic device, network PC, diagnostics equipment, and the like, and is not limited to portable devices. The mobile device 110 can receive and process data in any of a variety of data formats. The data format may include or be configured to operate with any programming format, protocol, or language including, but not limited to, JavaScript™, C++, iOS™, Android™, etc.

Included herein is a set of logic flows representative of example methodologies for performing novel aspects of the disclosed architecture. While, for purposes of simplicity of explanation, the one or more methodologies shown herein are shown and described as a series of acts, those of ordinary skill in the art will understand and appreciate that the methodologies are not limited by the order of acts. Some acts may, in accordance therewith, occur in a different order and/or concurrently with other acts from those shown and described herein. For example, those of ordinary skill in the art will understand and appreciate that a methodology can alternatively be represented as a series of interrelated states or events, such as in a state diagram. Moreover, not all acts illustrated in a methodology may be required for a novel implementation. A logic flow may be implemented in software, firmware, and/or hardware. In software and firmware embodiments, a logic flow may be implemented by computer executable instructions stored on at least one non-transitory computer readable medium or machine readable medium, such as an optical, magnetic or semiconductor storage. The example embodiments disclosed herein are not so limited.

The various elements of the example embodiments as previously described with reference to the figures may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The example embodiments described herein provide a technical solution to a technical problem. The various embodiments improve the functioning of the electronic device and the related system by providing an improved system and method for image capture, processing, and display. The various embodiments also serve to transform the state of various system components based on a dynamically determined system context. Additionally, the various embodiments effect an improvement in a variety of technical fields including the fields of dynamic data processing, electronic systems, mobile devices, image processing, motion sensing and capture, virtual reality, data sensing systems, human/machine interfaces, mobile computing, information sharing, and mobile communications.

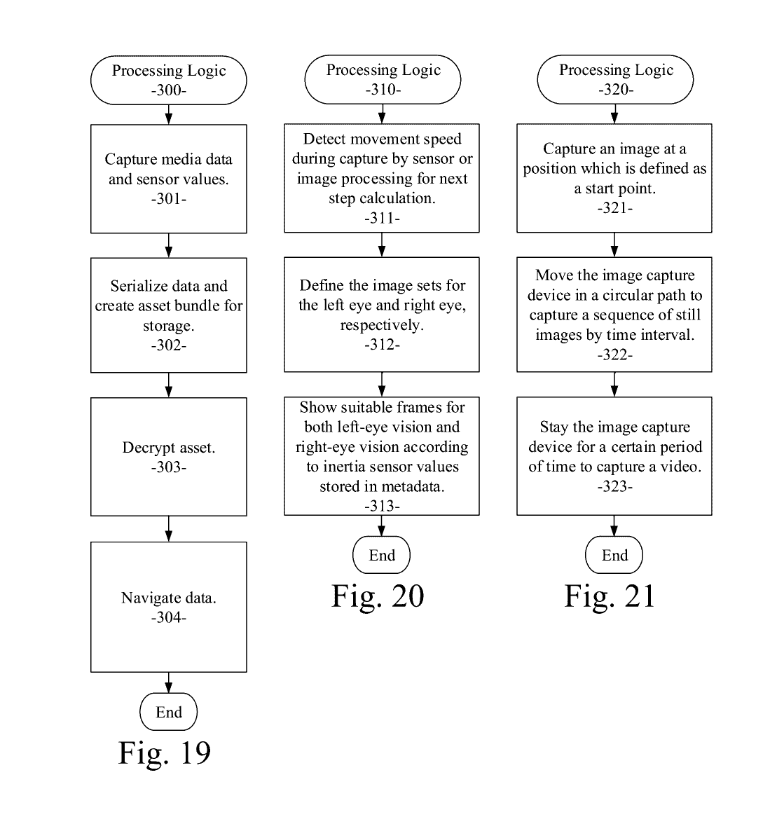

FIG. 19 is a processing flow diagram illustrating an example embodiment 300 of systems and methods for image capture, processing, and display as described herein. The system and method of an example embodiment is configured to: capture media data and sensor values (block 301); serialize data and create an asset bundle for storage (block 302); decrypt the asset (block 303); and navigate the data (block 304).

FIG. 20 is a processing flow diagram illustrating an example embodiment 310 of systems and methods for image capture, processing, and display as described herein. The system and method of an example embodiment is configured to: detect movement speed during image capture by sensor or image processing for a next step calculation (block 311); define the image sets for the left eye and right eye, respectively (block 312); and show suitable frames for both left eye vision and right eye vision according to inertia sensor values stored in metadata (block 313).

FIG. 21 is a processing flow diagram illustrating an example embodiment 320 of systems and methods for image capture, processing, and display as described herein. The system and method of an example embodiment is configured to: capture an image at a position which is defined as a start point (block 321); move the image capture device in a circular path to capture a sequence of still images by time interval (block 322); and stay the image capture device for a certain period of time to capture a video (block 323).

With general reference to notations and nomenclature used herein, the description presented herein may be disclosed in terms of program procedures executed on a computer or a network of computers. These procedural descriptions and representations may be used by those of ordinary skill in the art to convey their work to others of ordinary skill in the art. A procedure is generally conceived to be a self-consistent sequence of operations performed on electrical, magnetic, or optical signals capable of being stored, transferred, combined, compared, and otherwise manipulated. These signals may be referred to as bits, values, elements, symbols, characters, terms, numbers, or the like. It should be noted, however, that all of these and similar terms are to be associated with the appropriate physical quantities and are merely convenient labels applied to those quantities. Various embodiments may relate to apparatus or systems for performing processing operations. This apparatus may be specially constructed for a purpose, or it may include a general-purpose computer as selectively activated or reconfigured by a computer program stored in the computer.

The Abstract of the Disclosure is provided to allow the reader to quickly ascertain the nature of the technical disclosure. The Abstract should not be used to interpret or limit the scope or meaning of the claims. In addition, in the foregoing Detailed Description, it can be seen that various features are grouped together in a single embodiment for the purpose of streamlining the disclosure. As the following claims reflect, inventive subject matter lies in less than all features of a single disclosed embodiment. Thus, the following claims are hereby incorporated into the Detailed Description, with each claim standing on its own as a separate embodiment.

What is claimed is:

1. A mobile device comprising:
one or more data processors;
an image capture device to capture images;
a sensor device to detect movement of the mobile device; and
image capture and display processing logic, executable by the one or more data processors, to:
capture an image at a position defined as a start point using the image capture device;
move or rotate the image capture device in a circular path to capture a sequence of still images based on a time interval or an angle of rotation determined by the sensor device; and
stay the image capture device in a fixed location for a certain period of time to enable the automatic capture of one or more video clips by use of the image capture device.

2. The mobile device of claim 1 wherein the mobile device is one of a type of devices from the group consisting of: a laptop computer, a tablet computing system, a Personal Digital Assistant (PDA), a cellular telephone, a smartphone, and a web appliance.

3. The mobile device of claim 1 wherein the image capture and display processing logic being further configured to integrate the captured sequence of still images with the one or more video clips to produce an animated image stream, the still images and the video clips of the animated image stream being sequenced based on a corresponding time interval or an angle of rotation.

4. The mobile device of claim 3 wherein the image capture and display processing logic being further configured to: present a selected portion of the animated image stream on a display device of the mobile device, the selected portion being based on gestures or other user inputs applied on a touch screen or other user input device of the mobile device.

5. The mobile device of claim 3 wherein the image capture and display processing logic being further configured to: present a selected portion of the animated image stream on a display device of the mobile device, the selected portion being based on rotation of the mobile device to different directions or angles corresponding to a desired portion of the animated image stream.

6. The mobile device of claim 1 wherein the image capture and display processing logic being further configured to:
record rotational or angular degree information collected from the sensor device for each still image and each video clip;
determine an angular distance or measurement corresponding to the parallax for a user's left and right eyes; and
adjust a specific angle between each still image and each video clip to correspond to the determined angular distance or measurement corresponding to the parallax for the user's left and right eyes to simulate three-dimensional (3D) perspective for the user.

7. The mobile device of claim 1 wherein the image capture and display processing logic being further configured to: perform stereoscopic three-dimensional (3D) image stitching for a first eye of the user by using one full frame of an image as a first frame, cropping subsequent frames according to a pre-defined frame width, and arranging the first frame and the cropping subsequent frames together to form a wide angled image for a first eye.

8. The mobile device of claim 7 wherein the image capture and display processing logic being further configured to: perform stereoscopic three-dimensional (3D) image stitching for a second eye of the user by using the first frame, cropping subsequent frames according to a pre-defined frame width, and arranging the first frame and the cropping subsequent frames together to form a wide angled image for a second eye.

9. The mobile device of claim 7 wherein the image capture and display processing logic being further configured to: connect a last cropped subsequent frame with the first frame for a 360 degree view.

10. The mobile device of claim 8 wherein the image capture and display processing logic being further configured to: display side-by-side the wide angled image for the first eye and the wide angled image for the second eye together at the same time.

11. The mobile device of claim 10 wherein the wide angled image for the first eye and the wide angled image for the second eye are adjusted according to a corresponding parallax for a user's left and right eyes.

12. The mobile device of claim 1 wherein the mobile device is integrated into a virtual reality headset.

13. The mobile device of claim 7 wherein the image capture and display processing logic being further configured to: arrange a stitched still image as a background in accordance with a degree of angular rotation; and overlay a video clip at the degree of angular rotation as an insertion of the video clip into the stitched still image.

14. The mobile device of claim 7 wherein the image capture and display processing logic being further configured to: use one full frame of an image as a first frame aligned in a center position with full resolution or use a full frame for a video clip, cropping subsequent frames according to a pre-defined frame width.

15. The mobile device of claim 7 wherein the image capture and display processing logic being further configured to: arrange a stitched still image as a background in accordance with a degree of angular rotation; and overlay a video clip at the degree of angular rotation as an overlay of the video clip into the stitched still image replacing still images at the degree of angular rotation.

16. A method comprising:
capturing an image at a position defined as a start point using an image capture device;
moving or rotating the image capture device in a circular path to capture a sequence of still images based on a time interval or an angle of rotation determined by a sensor device; and
staying the image capture device in a fixed location for a certain period of time to enable the automatic capture of one or more video clips by use of the image capture device.

17. The method of claim 16 including integrating the captured sequence of still images with the one or more video clips to produce an animated image stream, the still images and the video clips of the animated image stream being sequenced based on a corresponding time interval or an angle of rotation.

18. The method of claim 17 including presenting a selected portion of the animated image stream on a display device, the selected portion being based on gestures or other user inputs applied on a touch screen or other user input device of a mobile device.

19. The method of claim 17 including presenting a selected portion of the animated image stream on a display device, the selected portion being based on rotation of the display device to different directions or angles corresponding to a desired portion of the animated image stream.

20. The method of claim 16 including recording rotational or angular degree information collected from the sensor device for each still image and each video clip; determining an angular distance or measurement corresponding to the parallax for a user's left and right eyes; and adjusting a specific angle between each still image and each video clip to correspond to the determined angular distance or measurement corresponding to the parallax for the user's left and right eyes to simulate three-dimensional (3D) perspective for the user.
